(19) United States
(12) Patent Application Publication
(10) Pub. No.: US 2009/0243429 A1
(43) Pub. Date: Oct. 1, 2009

(54) OPERATION APPARATUS

(75) Inventors: Yohko Naruse, Ichinomiya-shi (JP); Noriaki Kojima, Ogaki-shi (JP)

Correspondence Address: DITTHAVONG MORI & STEINER, P.C., 918 Prince St., Alexandria, VA, 22314, US

(73) Assignee: SANYO Electric Co., Ltd., Moriguchi-shi (JP)

(21) Appl. No.: 12/412,691

(22) Filed: Mar. 27, 2009

(30) Foreign Application Priority Data
Mar. 27, 2008 (JP) 2008-82330

(51) Int. Cl. H02N 1/00

(52) U.S. Cl. 310/309; 307/400

(57) ABSTRACT

An operation apparatus includes a first electrode, and a second electrode including an electric field or magnetic field generating region, wherein the first electrode and the second electrode are so arranged that a center of the first electrode in a movement direction and a center of the electric field or magnetic field generating region of the second electrode in the movement direction deviate from each other in an initial state.

### CROSS-REFERENCE TO RELATED APPLICATIONS

The priority application number JP2008-82330, Operation Apparatus, Mar. 27, 2008, Yohko Naruse, Noriaki Kojima, upon which this patent application is based is hereby incorporated by reference.

### BACKGROUND OF THE INVENTION

1. Field of the Invention

The present invention relates to an operation apparatus, and more particularly, it relates to an operation apparatus comprising a first electrode and a second electrode arranged to be opposed to the first electrode and generating an electric field or a magnetic field.

2. Description of the Background Art

An operation apparatus comprising a first electrode and a second electrode (electret film) arranged to be opposed to the first electrode and generating an electric field or a magnetic field is known in general.

In a conventional operation apparatus (electrostatic induction conversion device), two substrates are arranged to be opposed to each other, and a plurality of electret films (second electrodes) and conductors (first electrodes) formed in oblong shapes or square shapes are formed on opposed surfaces of the respective substrate. In this electrostatic induction conversion device, the electret films (second electrodes) and the conductors (first electrodes) relatively move from a state where the electret films and the conductors are opposed to each other, thereby changing the quantity of charges stored in the conductors by electrostatic induction. This changed quantity of charges is extracted, thereby generating power.

### SUMMARY OF THE INVENTION

An operation apparatus according to a first aspect of the present invention comprises a first electrode, and a second electrode arranged to be opposed to the first electrode, capable of moving relatively to the first electrode, and including an electric field or magnetic field generating region, wherein the first electrode and the second electrode are so arranged that a center of the first electrode in a movement direction and a center of the electric field or magnetic field generating region of the second electrode in the movement direction deviate from each other in an initial state.

A power generator according to a second aspect of the present invention comprises a collector, and an electret film arranged to be opposed to the collector, capable of moving relatively to the collector, and including an electric field generating region, wherein the collector and the electret film are so arranged that a center of the collector in a movement direction and a center of the electric field generating region of the electret film in the movement direction deviate from each other in an initial state, and power is generated by electrostatic induction generated by relative movement of the collector and the electret film.

An actuator according to a third aspect of the present invention comprises a first electrode, and a second electrode arranged to be opposed to the first electrode, capable of moving relatively to the first electrode, and including an magnetic field generating region, wherein the first electrode and the second electrode are so arranged that a center of the first electrode in a movement direction and a center of the magnetic field generating region of the second electrode in the movement direction deviate from each other in an initial state, and the first electrode and the second electrode relatively move by electromagnetic interaction between the first electrode and the second electrode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view of an electrostatic power generator according to a first embodiment of the present invention;

FIG. 2 is a sectional view taken along the line 200-200 in FIG. 1;

FIG. 3 is a sectional view taken along the line 210-210 in FIG. 1;

FIGS. 4 and 5 are diagrams for illustrating a simulation of an intensity (potential) of an electric field generated by charges stored in electret films;

FIG. 6 is a diagram showing the changed quantity of potentials causing electrostatic induction in a collector before and after the collector move by 10 μm;

FIG. 7 is a sectional view of an electrostatic power generator according to a second embodiment of the present invention;

FIG. 8 is a sectional view of an electrostatic power generator according to a third embodiment of the present invention;

FIG. 9 is a sectional view of an electrostatic power generator according to a fourth embodiment of the present invention;

FIG. 10 is a sectional view of an electrostatic power generator according to a fifth embodiment of the present invention;

FIG. 11 is a sectional view of an electromagnetic actuator according to a sixth embodiment of the present invention;

FIG. 12 is a plan view of an electromagnetic actuator according to the sixth embodiment of the present invention;

FIG. 13 is a sectional view of an electrostatic power generator according to a first modification of the first embodiment of the present invention;

FIG. 14 is a sectional view of an electrostatic power generator according to a second modification of the first embodiment of the present invention;

FIG. 15 is a sectional view of an electrostatic power generator according to a modification of the second embodiment of the present invention;

FIG. 16 is a sectional view of an electrostatic power generator according to a modification of the third embodiment of the present invention;

FIG. 17 is a sectional view of an electrostatic power generator according to a modification of the fourth embodiment of the present invention; and

FIG. 18 is a sectional view of an electrostatic power generator according to a modification of the fifth embodiment of the present invention.

### DESCRIPTION OF THE PREFERRED EMBODIMENTS

The embodiments of the present invention will be hereinafter described with reference to drawings.

### First Embodiment

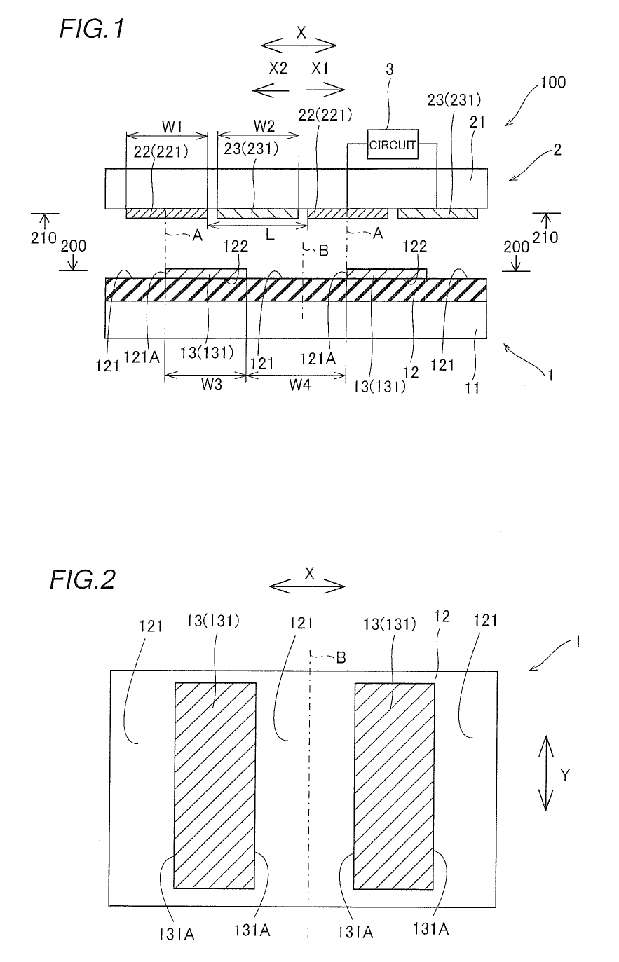

A structure of an electrostatic power generator 100 according to a first embodiment of the present invention will be described with reference to FIGS. 1 to 3. This embodiment of the present invention is applied to the electrostatic power generator 100 employed as an exemplary operation apparatus.

In this electrostatic power generator 100 according to the first embodiment, a stator 1 and a mover 2 are arranged at a prescribed interval therebetween to be opposed to each other, as shown in FIG. 1. The first embodiment will be hereinafter described in detail.

In the stator 1, an electret film 12 is formed on a surface of a fixed substrate 11, as shown in FIG. 1. The electret film 12 is an example of the “second electrode” in the present invention. Negative charges are injected into the electret film 12 by corona discharge. The guard electrodes 13 made of a conductive member are formed on a surface of the electret film 12 at a prescribed interval (width W4), as shown in FIGS. 1 and 2. The guard electrodes 13 are formed by a plurality of electrode portions 131, and the respective electrode portions 131 are oblongly formed. The electrode portions 131 are examples of the “third electrode” in the present invention. The plurality of electrode portions 131 are arranged at a regular interval. The guard electrodes 13 are formed on the surface of the electret film 12, whereby an electric field resulting from negative charges is generated from regions 121 formed with no guard electrode 13 on the surface of the electret film 12 toward the mover 2 and no electric field is generated from regions 122 formed with the guard electrodes 13 on the surface of the electret film 12. The regions 121 are examples of the “electric field or magnetic field generating region” in the present invention. Regions having strong and weak electric fields are formed between the electret film 12 and the mover 2. The regions 121 are so formed as to extend in a direction Y intersecting with a movement direction of the mover 2.

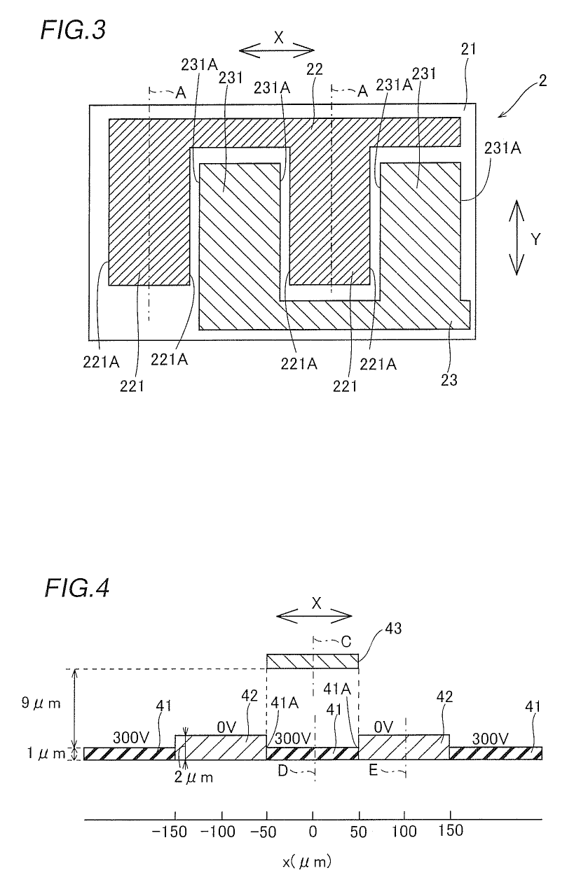

In the mover 2, a collector 22 and a collector 23 are formed on a surface of a movable substrate 21 as shown in FIG. 1. As shown in FIG. 3, the collector 22 and the collector 23 are formed in interdigital shapes including a plurality of electrode portions 221 and electrode portions 231 respectively. The electrode portions 221 and 231 are examples of the “first electrode portion (first electrode)” and the “second electrode portion (first electrode)” in the present invention, respectively. The collector 22 and the collector 23 are so arranged that the electrode portion 231 forming the interdigital collector 23 is held between the two electrode portions 221 forming the interdigital collector 22 (the electrode portions 221 and the electrode portions 231 are alternately arranged). As shown in FIG. 1, the collector 22 and the collector 23 are electrically connected to each other through a circuit 3.

As shown in FIGS. 2 and 3, the electrode portions 221 of the collector 22, the electrode portions 231 of the collector 23 and the electrode portions 131 of the guard electrodes 13 are so formed as to extend in the direction Y. The electrode portions 221, the electrode portions 231 and the electrode portions 131 are so formed that sides 221A and 231A, extending in the direction Y, of the electrode portions 221 and the electrode portions 231 and sides 131A, extending in the direction Y, of the electrode portions 131 are parallel to each other.

As shown in FIG. 1, a width W1 of the electrode portions 221 of the collector 22 in a direction X, a width W2 of the electrode portions 231 of the collector 23 in the direction X and a width W3 of the electrode portions 131 of the guard electrodes 13 in the direction X are substantially equal to each other. The direction X is an example of the “movement direction” in the present invention. The width W4 of the regions 121 formed with no guard electrode 13 on the surface of the electret film 12 is rendered larger than the width W1 of the electrode portions 221 of the collector 22 in the direction X, the width W2 of the electrode portions 231 of the collector 23 in the direction X and the width W3 of the electrode portions 131 of the guard electrodes 13 in the direction X. While two of the electrode portions 221, the electrode portions 231 and the electrode portions 131 are arranged in FIG. 1, at least three of the electrode portions 221, the electrode portions 231 and the electrode portions 131 may be provided.

According to the first embodiment, in an initial state, the electret film 12 and the collector 22 are so arranged with deviation that centers A of the electrode portions 221 of the collector 22 in the direction X (short-direction) and ends 121A of regions 121, where an electric field is generated, on the surface of the electret film 12 coincide with each other in plan view, as shown in FIG. 1. In other words, the center A of each of the plurality of electrode portions 221 of the collector 22 and a center B of each of the plurality of regions 121, where an electric field is generated, of the electret film 12 are arranged to deviate from each other by a substantially regular interval. The “coincide in plan view” includes a range of “substantially coincide”. Pitches L of the plurality of electrode portions 221 in the direction X are so controlled that the centers A of the electrode portions 221 in the direction X coincide with the ends 121A of the plurality of regions 121 of the electret film 12 in plan view. The “initial state” means a state where the movable substrate 21 stands still while balancing gravitational force applied to the movable substrate 21 and the like, namely a state where the movable substrate 21 approaches an end side along arrows X1 or X2 of the electrostatic power generator 100 or a state where the movable substrate 21 is supported by an elastic body such as a spring.

(Simulation)

A simulation conducted for explaining the relation between a position of the collector and the changed quantity of potentials causing electrostatic induction in the collector will be described with reference to FIGS. 4 to 6.

As shown in FIG. 4, guard electrodes 42 having a thickness of 2 μm and a width of 100 μm are arranged between three electret films 41 having a thickness of about 1 μm and a width of 100 μm. The electret films 41 store a charge of 300 V. The potential of the guard electrodes 42 is controlled to 0 V. A collector 43 having a width of 100 μm is so arranged as to be opposed to the electret film 41 arranged on a center in the three electret films 41 at a distance of 9 μm.

An intensity of a potential at a point at a distance of 9 μm from the electret film 41 will be now described. As shown in FIG. 5, a potential at a region (x=−150 μm to −50 μm and x=50 μm to 150 μm) opposed to each guard electrode 42 was about 25 V to about 90 V. In a region opposed to each electret film 41 (x=−50 μm to 50 μm), on the other hand, a potential was about 90 V to about 273 V. In the vicinity of boundaries (x=−150 μm, −50 μm, 50 μm and 150 μm) between the electret films 41 and the guard electrodes 42, it has been proved that changes of the potentials are increased.

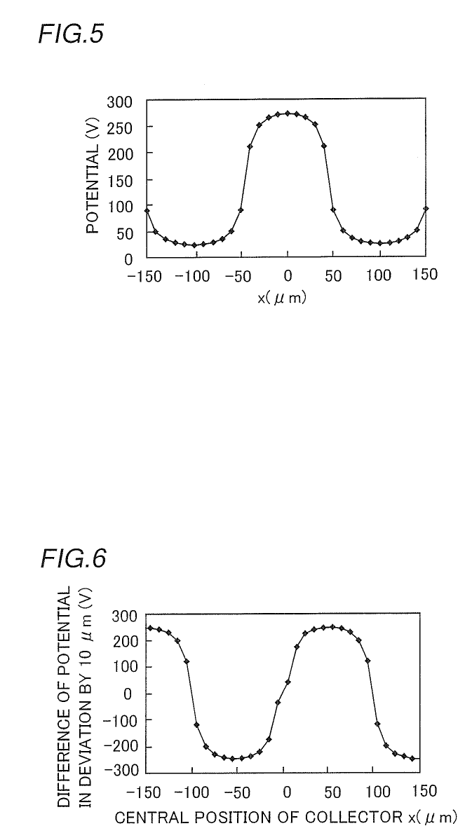

The changed quantity of potentials causing electrostatic induction in the collector 43 before and after moving the collector 43, which is arranged to be opposed to the electret film 41 in the three electret films 41 shown in FIG. 4, by 10 μm in a direction X will be described. As shown in FIG. 6, when a center C (see FIG. 4) of the collector 43 in the direction X and a center D (see FIG. 4) of the electret film 41 in the direction X coincide with each other (x=0 μm), an absolute value of the changed quantity of potentials causing electrostatic induction in the collector 43 was minimum, almost 0 V. When the center C of the collector 43 in the direction X and a center E (see FIG. 4) of each guard electrode 42 in the direction X coincide with each other (x=−100 μm and 100 μm), an absolute value of the changed quantity of potentials causing electrostatic induction in the collector 43 was minimum, almost 0 V. When the center C of the collector 43 in the direction X and an end 41A (see FIG. 4) of each electret film 41 coincide with each other (x=−150 μm, −50 μm, 50 μm and 150 μm), an absolute value of the changed quantity of potentials causing electrostatic induction in the collector 43 was maximum, about 248 V. In other words, it has been confirmed that the changed quantity of potentials causing an electrostatic induction in the collector 43 before and after moving the collector 43 by 10 μm in the direction X is increased when the center C of the collector 43 in the direction X is located in the vicinity of the region (x=−150 μm, −50 μm, 50 μm and 150 μm) where the changed amount in the direction X of the intensity of the electric field caused from the electret film 41 is large, shown in FIG. 5, while the changed quantity of potentials causing an electrostatic induction in the collector 43 before and after moving the collector 43 by 10 μm in the direction X is reduced when the center C of the collector 43 in the direction X is located in the vicinity of the region (x=−100 μm, 0 μm and 100 μm) where the changed amount in the direction X of the intensity of the electric field caused from the electret film 41 is small.

A power generating operation of the electrostatic power generator 100 according to the first embodiment of the present invention will be now described with reference to FIG. 1.

As shown in FIG. 1, in the initial state of the electrostatic power generator 100, the centers A of the electrode portions 221 in the direction X and the ends 121A of the regions 121 of the electret film 12 are arranged to coincide with each other in plan view. In other words, the collector 22 and the regions 121 of the electret film 12 are arranged to overlap with each other in plan view. In this state, the collector 22 and the collector 23 store substantially the same quantity of positive charges by electrostatic induction.

When the mover 2 moves in the direction X (along arrow X1, for example), the collector 22 and the guard electrodes 13 are opposed to each other and the collector 23 and the regions 121 of the electret film 12 are opposed to each other. Thus, the quantity of positive charges stored in the collector 23 are increased and the quantity of positive charges stored in the collector 22 are reduced. When the mover 2 moves along arrow X2, the collector 23 and the guard electrodes 13 are opposed to each other and the collector 22 and the regions 121 of the electret film 12 are opposed to each other. Thus, the quantity of positive charges stored in the collector 23 are reduced and the quantity of positive charges stored in the collector 22 are increased. The changed quantity of positive charges stored in the collector 22 and the collector 23 are extracted by the circuit 3, thereby generating power.

According to the first embodiment, as hereinabove described, in the initial state, the collector 22 and the electret film 12 are so arranged with deviation that the centers A of the electrode portions 221 of the collector 22 in the direction X and the ends 121A of the regions 121 of the electret film 12 substantially coincide with each other in plan view, whereby change of the intensity (potential) of an electric field is large on the surfaces of the ends 121A of the regions 121 of the electret film 12 as shown in FIG. 5, and hence power can be sufficiently generated also when relative movement of the collector 22 and the electret film 12 is small.

According to the first embodiment, as hereinabove described, the center A of each of the plurality of electrode portions 221 of the collector 22 and the center B of each of the plurality of the regions 121, where an electric field is generated, of the electret film 12 deviate from each other by the substantially regular interval, whereby the quantities of charges induced in the plurality of electrode portions 221 can be rendered the same, and hence an operation of the electrostatic power generator 100 can be stabilized.

According to the first embodiment, as hereinabove described, the electrostatic power generator 100 comprises the electrode portions 221 of the collector 22 and the electrode portions 231 of the collector 23, whereby power can be generated by the two electrodes of the electrode portions 221 and the electrode portions 231 and hence the quantity of power generation can be increased.

According to the first embodiment, as hereinabove described, a plurality of the guard electrodes 13 are arranged at the prescribed intervals on the surface of the electret film 12 so that a plurality of the regions 121, where an electric field is generated, of the electret film 12 are provided, whereby the quantity of power generation can be increased as compared with a case of a single region 121.

### Second Embodiment

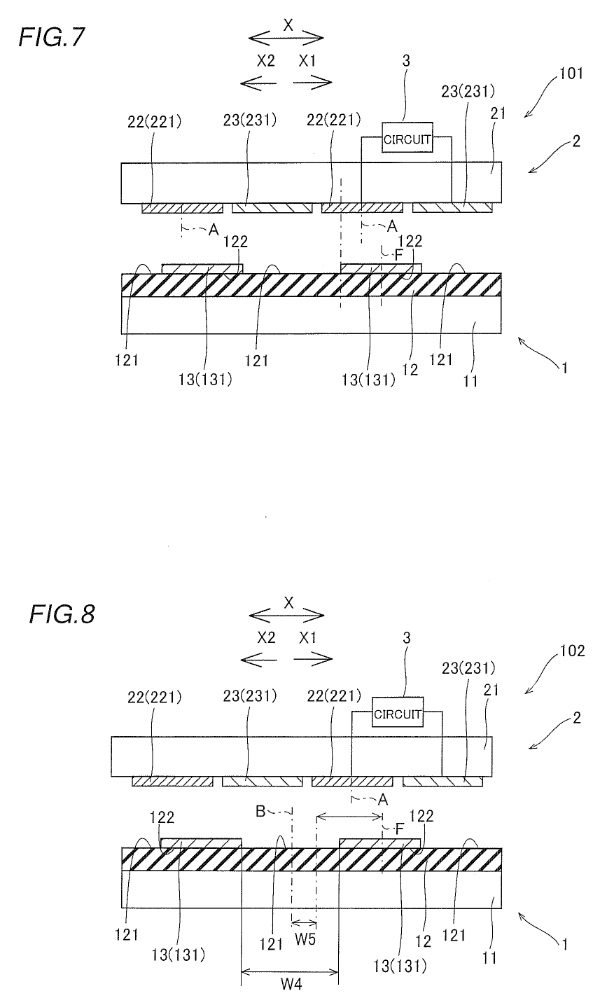

Referring to FIG. 7, a collector 22 and guard electrodes 13 are so arranged that centers A of electrode portions 221 in a direction X and centers F of the guard electrodes 13 deviate from each other in an electrostatic power generator 101 according to a second embodiment, dissimilarly to the aforementioned first embodiment.

In this electrostatic power generator 101 according to the second embodiment, the collector 22 and the guard electrodes 13 are so arranged that the centers A of the electrode portions 221 in the direction X and the centers F of the guard electrodes 13 deviate from each other in an initial state, as shown in FIG. 7. This state means a state where the center C of the collector 43 in the direction X and the centers E of the guard electrodes 42 do not coincide with each other (x=−100 μm and 100 μm) in FIG. 4.

According to the second embodiment, as hereinabove described, the collector 22 and the guard electrodes 13 are so arranged that the centers A of the electrode portions 221 in the direction X and the centers F of the guard electrodes 13 deviate from each other, whereby the changed quantity of potentials causing electrostatic induction in the collector 22 is not substantially 0, dissimilarly to a case where the centers A of the electrode portions 221 in the direction X and the centers F of the guard electrodes 13 coincide with each other (x=100 μm or −100 μm shown in FIG. 6). Thus, the electrostatic power generator 101 can generate power even when relative movement of the collector 22 and the electret film 12 is small.

### Third Embodiment

Referring to FIG. 8, a center A of each of electrode portions 221 of a collector 22 in a direction X and a center B of each of regions 121 of an electret film 12 deviate from each other by at least a width W5 which is one-fourth of a width W4 of each of the regions 121 of the electret film 12, in an electrostatic power generator 102 according to a third embodiment, dissimilarly to the aforementioned first embodiment.

In this electrostatic power generator 102 according to the third embodiment, the collector 22 and the electret film 12 are so arranged that the center A of each of the electrode portions 221 in the direction X and the center B of each of the regions 121 of the electret film 12 deviate from each other by at least the width W5 which is one-fourth of the width W4 of each of the regions 121 of the electret film 12 (at most one-half of the width W4 of each of the regions 121 of electret film 12), in the initial state, as shown in FIG. 8. The collector 22 is so arranged as to overlap with the regions 121 of the electret film 12 in plan view. This state means a case where the center C of the collector 43 in the direction X is located at a position of at least 25 μm and less than 100 μm (25 μm≦x<100 μm) in FIG. 4.

According to the third embodiment, as hereinabove described, in the initial state, the collector 22 and the electret film 12 are so arranged that the center A of each of the electrode portions 221 of the collector 22 in the direction X and the center B of each of the regions 121, where an electric field is generated, of the electret film 12 in the direction X deviate from each other by at least the width W5 which is one-fourth of the width W4 of each of the regions 121 in the direction X and the collector 22 and the regions 121 of the electret film 12 overlap with each other in plan view. Thus, the center A of each of the electrode portions 221 and the center B of each of the regions 121 of the electret film 12 do not overlap with each other, and hence the quantity of power generation of the electrostatic power generator 102 can be inhibited from being substantially 0 even when relative movement of the collector 22 and the electret film 12 is small dissimilarly to a case where the center A of each of the electrode portions 221 and the center B of each of the regions 121 of the electret film 12 overlap with each other.

### Fourth Embodiment

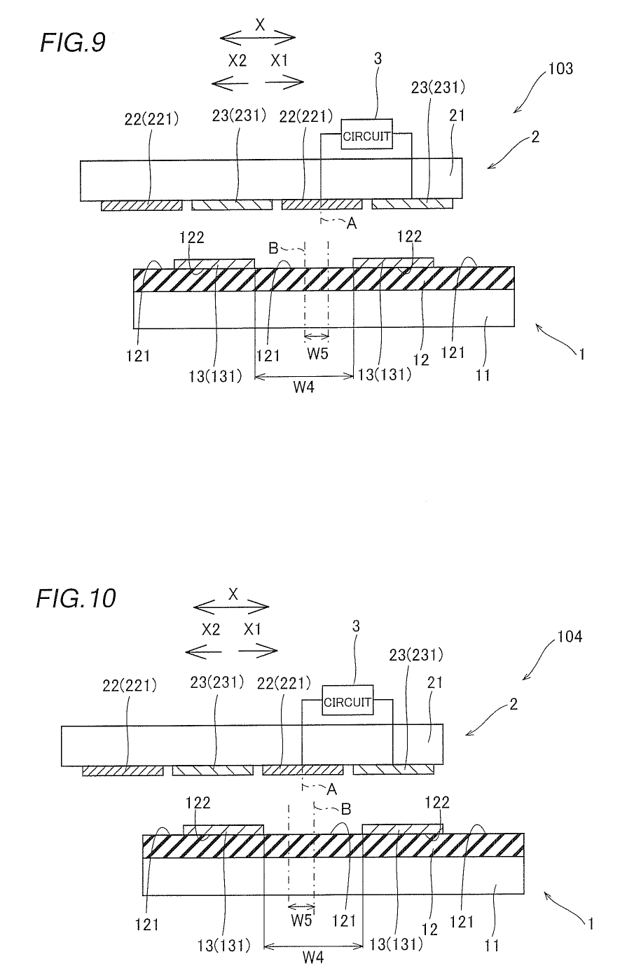

Referring to FIG. 9, deviation between a center A of each of electrode portions 221 of a collector 22 in a direction X and a center B of each of regions 121 of an electret film 12 in the direction X is smaller than a width W5 which is one-fourth of a width W4 of each of the regions 121 of the electret film 12, in an electrostatic power generator 103 according to a fourth embodiment, dissimilarly to the aforementioned first embodiment.

In this electrostatic power generator 103 according to the fourth embodiment, the collector 22 and the electret film 12 are so arranged that the deviation between the center A of each of the electrode portions 221 in the direction X and the center B of each of the regions 121 of the electret film 12 in the direction X is smaller than the width W5 which is one-fourth of the width W4 of each of the regions 121 of the electret film 12 in an initial state, as shown in FIG. 9. The center A of each of the electrode portions 221 in the direction X deviates along arrow X1 with respect to the center B of each of the regions 121 of the electret film 12 in the direction X. This state means a case where the center C of the collector 43 in the direction X is located at a position of more than 0 μm and less than 25 μm (0 μm<x<25 μm) in FIG. 4.

According to the fourth embodiment, as hereinabove described, the collector 22 and the electret film 12 are so arranged that the deviation between the center A of each of the electrode portions 221 in the direction X and the center B of each of the regions 121 of the electret film 12 in the direction X is smaller than the width W5 which is one-fourth of a width W4 of each of the regions 121 of the electret film 12 in the initial state. Thus, the center A of each of the electrode portions 221 and the center B of each of the regions 121 of the electret film 12 do not overlap with each other, and hence the quantity of power generation of the electrostatic power generator 103 can be inhibited from being substantially 0 even when relative movement of the collector 22 and the electret film 12 is small, dissimilarly to a case where the center A of each of the electrode portions 221 and the center B of each of the regions 121 of the electret film 12 overlap with each other. The center A of each of the electrode portions 221 in the direction X deviates along arrow X1 with respect to the center B of each of the regions 121 of the electret film 12 in the direction X, whereby the quantity of power generation can be increased with respect to relative movement along arrow X1 (movement in a direction in which x is larger than 25 μm, shown in FIG. 6).

### Fifth Embodiment

Referring to FIG. 10, deviation between a center A of each of electrode portions 221 of a collector 22 in a direction X and a center B of each of regions 121 of an electret film 12 is smaller than a width W5 which is one-fourth of a width W4 of each of the regions 121 of the electret film 12, in an electrostatic power generator 104 according to a fifth embodiment, dissimilarly to the aforementioned first embodiment.

In this electrostatic power generator 104 according to the fifth embodiment, the collector 22 and the electret film 12 are so arranged that the deviation between the center A of each of the electrode portions 221 in the direction X and the center B of each of the regions 121 of the electret film 12 is smaller than the width W5 which is one-fourth of the width W4 of each of the regions 121 of the electret film 12 in an initial state, as shown in FIG. 10. The center A of each of the electrode portions 221 in the direction X deviates along arrow X2 with respect to the center B of each of the regions 121 of the electret film 12 in the direction X. This state means a case where the center C of the collector 43 in the direction X is located at a position of more than −25 μm and less than 0 μm (−25 μm<x<0 μm) in FIG. 4.

According to the fifth embodiment, as hereinabove described, the collector 22 and the electret film 12 are so arranged that the deviation between the center A of each of the electrode portions 221 in the direction X and the center B of each of the regions 121 of the electret film 12 in the direction X is smaller than the width W5 which is one-fourth of a width W4 of each of the regions 121 of the electret film 12 in the initial state. Thus, the center A of each of the electrode portions 221 and the center B of each of the regions 121 of the electret film 12 do not overlap with each other, and hence the quantity of power generation of the electrostatic power generator 104 can be inhibited from being substantially 0 even when relative movement of the collector 22 and the electret film 12 is small, dissimilarly to a case where the center A of each of the electrode portions 221 and the center B of each of the regions 121 of the electret film 12 overlap with each other. The center A of each of the electrode portions 221 in the direction X deviates along arrow X2 with respect to the center B of each of the regions 121 of the electret film 12 in the direction X, whereby the quantity of power generation can be increased with respect to relative movement along arrow X2 (movement in a direction in which x is smaller than −25 μm, shown in FIG. 6).

### Sixth Embodiment

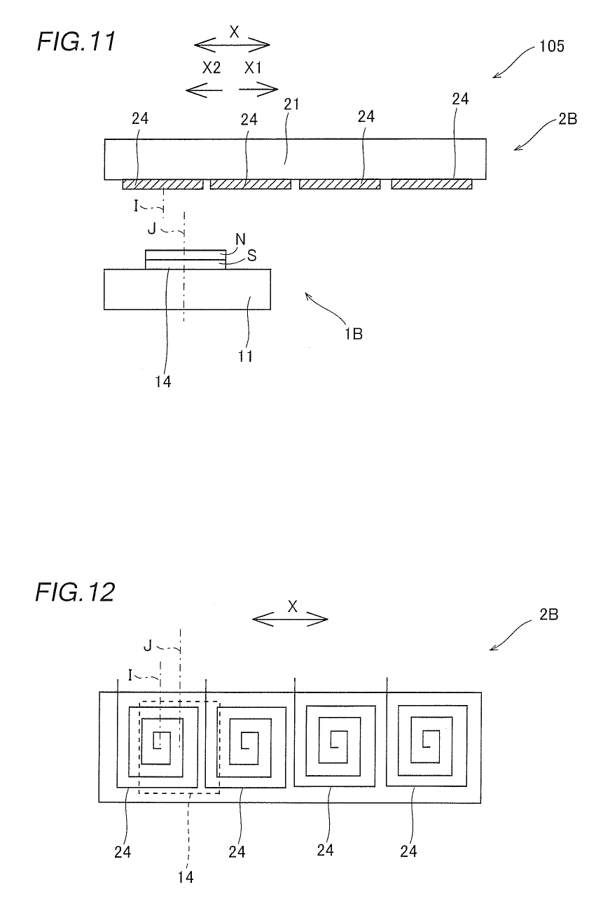

Referring to FIGS. 11 and 12, a sixth embodiment of the present invention is applied to an electromagnetic actuator 105 employed as an exemplary operation apparatus, dissimilarly to the aforementioned first to fifth embodiments.

In this electromagnetic actuator 105 according to the sixth embodiment, a stator 1B and a mover 2B are arranged at a prescribed interval therebetween to be opposed to each other, as shown in FIG. 11. The sixth embodiment will be hereinafter described in detail.

As shown in FIG. 11, a magnet 14 is formed on a surface of a fixed substrate 11 in a stator 1B. The magnet 14 is an example of the “second electrode” in the present invention. The surface of the magnet 14 is an example of the “electric field or magnetic field generating region” in the present invention. As shown in FIGS. 11 and 12, spiral coils 24 are formed on a surface of the movable substrate 21 in the mover 2B. The spiral coils 24 are examples of the “first electrode” in the present invention. According to the sixth embodiment, the spiral coils 24 and the magnet 14 are so arranged that centers I of spiral coils 24 in a direction X and a center J of the magnet 14 in the direction X deviate from each other at a prescribed interval in an initial state.

An operation of the electromagnetic actuator 105 according to the sixth embodiment of the present invention will be now described with reference to FIGS. 11 and 12.

A current is fed to the spiral coils 24 shown in FIGS. 11 and 12, thereby generating an magnetic field of a north or south pole on the spiral coils 24. A Direction of the current fed to the plurality of spiral coils 24 is so controlled that the magnet 14 is movable. Then the stator 1B and the mover 2B relatively move between the magnet 14 and the spiral coils 24 by repulsion or attraction.

The effects of the sixth embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

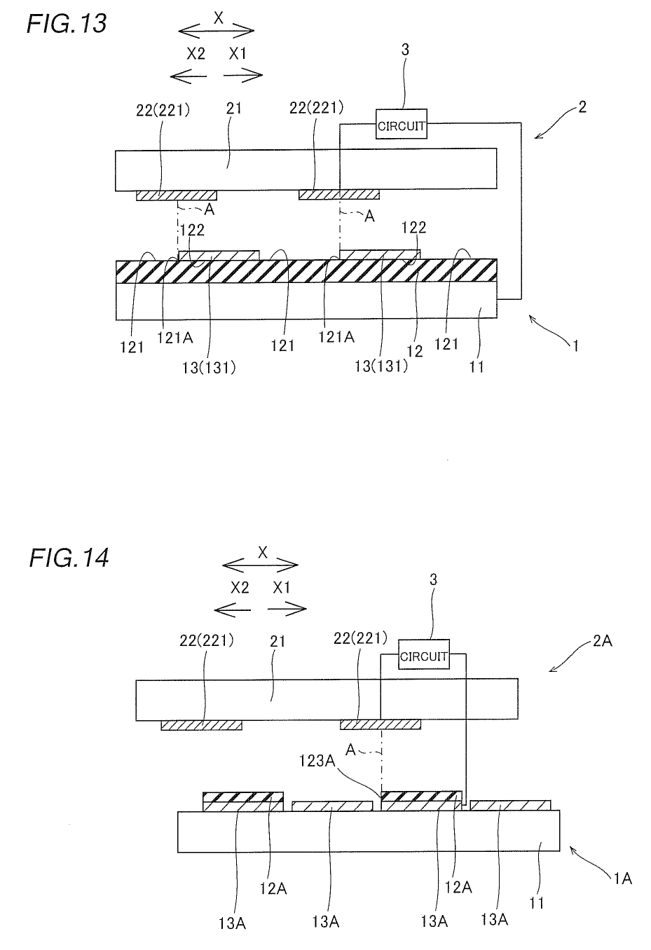

For example, while the collector 22 and the collector 23 are formed on the surface of the movable substrate 21 in the aforementioned first embodiment, the present invention is not restricted to this but only the collector 22 may be formed on the surface of the movable substrate 21 as shown in FIG. 13. In this case, the collector 22 and the fixed substrate 11 are connected to each other through the circuit 3. The fixed substrate 11 is formed by a conductive member.

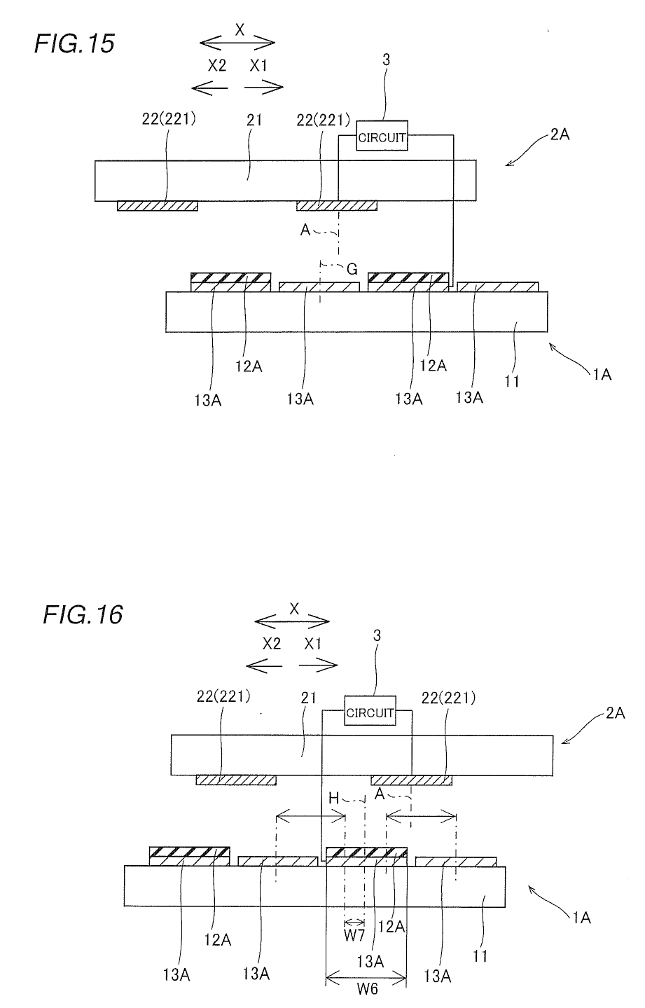

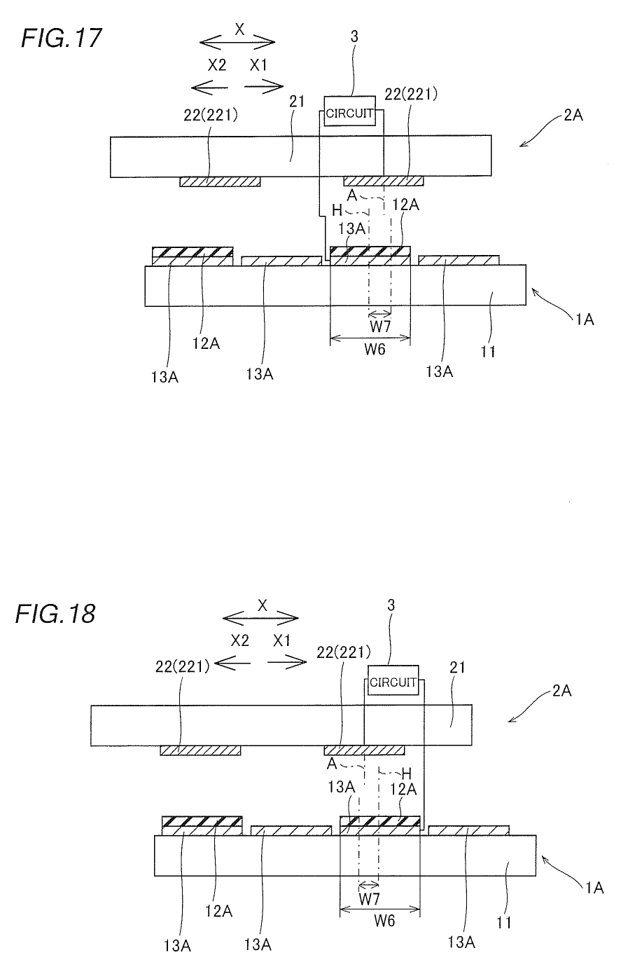

While the electret film 12 is formed on the surface of the fixed substrate 11 in each of the aforementioned first to fifth embodiments, the present invention is not restricted to this but oblong guard electrodes 13A may be formed on a surface of a fixed substrate 11 and oblong electret films 12A may be formed on a surface of the guard electrodes 13A as shown in FIGS. 14 to 18. A collector 22 is formed on a surface of a movable substrate 21, and the collector 22 and the guard electrodes 13A are connected to each other through a circuit 3. The positional relations between the collectors 22 and the guard electrodes 13A shown in FIGS. 14 to 18 correspond to the aforementioned first to fifth embodiments respectively. More specifically, in FIG. 14, centers A of electrode portions 221 of the collector 22 in a direction X and ends 123A of the electret films 12A substantially coincide with each other in plan view. In FIG. 15, the collector 22 and the electret films 12A are so arranged that centers A of electrode portions 221 in a direction X and centers G of the guard electrodes 13A do not coincide with each other. In FIG. 16, a centers A of each of electrode portions 221 of the collector 22 in a direction X and a center H of the corresponding electret film 12A in the direction X deviate from each other by at least a width W7 which is one-fourth of a width W6 of each electret film 12A in the direction X. In FIG. 17, a center A of each of electrode portions 221 of the collector 22 in a direction X and a center H of the corresponding electret film 12A in the direction X deviate from each other along arrow X1 by less than a width W7 which is one-fourth of a width W6 of each electret film 12A in the direction X. In FIG. 18, a centers A of each of electrode portion 221 of the collector 22 in a direction X and a center H of the corresponding electret film 12A in the direction X deviate from each other along arrow X2 by less than a width W7 which is one-fourth of a width W6 of each electret film 12A in the direction X.

While the collectors are interdigitally formed in the aforementioned first to fifth embodiments, the present invention is not restricted to this but the collectors may be oblongly formed.

While the electrostatic power generator are formed by the plurality of collectors and the plurality of regions, where an electric field is generated, of the electret film in each of the aforementioned first to fifth embodiments, the present invention is not restricted to this but the electrostatic power generator may be formed by a single collector and an single electret film.

While negative charges are injected into the electret film in each of the aforementioned first to fifth embodiments, the present invention is not restricted to this but positive charges may be injected into the electret film.

While each of the collectors includes the two electrode portions and the guard electrodes are formed by the two electrode portions in each of the aforementioned first to fifth embodiments, the present invention is not restricted to this but the collector may include three or more electrode portions and the guard electrodes may be formed by three or more electrode portions.

While the centers A of the plurality of electrode portions 221 of the collector 22 and the centers B of the plurality of regions 121 of the electret film 12 deviate from each other by the same width respectively in each of the aforementioned first to fifth embodiments, the present invention is not restricted to this but the center A of a part of the electrode portions 221 in the plurality of electrode portions 221 of the collector 23 and the center B of a part of the plurality of regions 121 of the electret film 12, corresponding to the part of the electrode portions 221 may be formed to deviate from each other by the same width respectively.

While each of the aforementioned first to sixth embodiments of the present invention is applied to the electrostatic power generator or the electromagnetic actuator which is an exemplary operation apparatus, the present invention is not restricted to this but the present invention may be applied to an electrostatic actuator or the like so far as the same is an operation apparatus having opposed electrodes.

What is claimed is:

1. An operation apparatus comprising:
a first electrode; and
a second electrode arranged to be opposed to said first electrode, capable of moving relatively to said first electrode, and including an electric field or magnetic field generating region, wherein
said first electrode and said second electrode are so arranged that a center of said first electrode in a movement direction and a center of said electric field or magnetic field generating region of said second electrode in said movement direction deviate from each other in an initial state.

2. The operation apparatus according to claim 1, wherein
a plurality of electrode portions of said first electrode and a plurality of said electric field or magnetic field generating regions of said second electrode are provided, and respective centers of said plurality of electrode portions of said first electrode in a movement direction and respective centers of said plurality of electric field or magnetic field generating regions in said movement direction deviate from each other.

3. The operation apparatus according to claim 2, wherein
said plurality of electrode portions of said first electrode are provided at a substantially regular interval, said plurality of electric field or magnetic field generating regions of said second electrode are provided at a substantially regular interval, and respective centers of said plurality of electrode portions of said first electrode in a movement direction and respective centers of said plurality of electric field or magnetic field generating regions in said movement direction deviate from each other at a substantially regular interval.

4. The operation apparatus according to claim 2, wherein
said first electrode includes a plurality of first electrode portions electrically connected to each other and a plurality of second electrode portions provided separately from said first electrode portions and electrically connected to each other, and
said first electrode portions and said second electrode portions are alternately arranged, respective centers of both of said first electrode portions and said second electrode portions in the movement direction of said first electrode and respective centers of said electric field or magnetic field generating regions of said second electrode in said movement direction deviate from each other.

5. The operation apparatus according to claim 4, wherein
respective widths of said first and second electrode portions in a direction along the movement direction of said first electrode are substantially equal to each other.

6. The operation apparatus according to claim 1, wherein
said first electrode and said second electrode are so arranged with deviation that the center of said first electrode in said movement direction and an end of said electric field or magnetic field generating region of said second electrode substantially coincide with each other in plan view in the initial state.

7. The operation apparatus according to claim 6, wherein
a plurality of electrode portions of said first electrode and a plurality of said electric field or magnetic field generating regions of said second electrode are provided, and are so arranged with deviation that respective centers of said plurality of electrode portions of said first electrode in a movement direction and respective ends of said plurality of electric field or magnetic field generating regions substantially coincide with each other in plan view.

8. The operation apparatus according to claim 1, wherein
said first electrode and said second electrode are so arranged that the center of said first electrode in said movement direction and the center of said electric field or magnetic field generating region of said second electrode in said movement direction deviate from each other by at least one-forth and at most one-half of a width of said electric field or magnetic field generating region in said movement direction in the initial state.

9. The operation apparatus according to claim 1, wherein
said first electrode and said second electrode are so arranged that the center of said first electrode in said movement direction and the center of said electric field or magnetic field generating region of said second electrode in said movement direction deviate from each other by less than one-forth of a width of said electric field or magnetic field generating region in said movement direction in the initial state.

10. The operation apparatus according to claim 1, wherein
said first electrode includes a collector and said second electrode includes an electret film, and
said collector and said electret film are so arranged that a center of said collector in a movement direction and a center of an electric field generating region of said electret film in said movement direction deviate from each other in an initial state, and power is generated by electrostatic induction generated by relative movement of said collector and said electret film.

11. The operation apparatus according to claim 1, wherein
said first electrode includes a coil and said second electrode includes a magnet, and
said coil and said magnet are so arranged that a center of said coil in a movement direction and a center of a magnetic field generating region of said magnet in said movement direction deviate from each other in an initial state, and said coil and said magnet relatively move by electromagnetic interaction between said coil and said magnet.

12. The operation apparatus according to claim 1, further comprising a third electrode provided to be adjacent to said electric field or magnetic field generating region of said second electrode, wherein
said first electrode and said third electrode are so arranged that the center of said first electrode in said movement direction and a center of said third electrode in said movement direction deviate from each other in an initial state.

13. The operation apparatus according to claim 12, wherein
said first electrode includes a collector, said second electrode includes an electret film, and said third electrode includes a guard electrode for blocking an electric field resulting from charges stored in said electret film, and
said collector and said guard electrode are so arranged that a center of said collector in said movement direction and a center of said guard electrode in said movement direction deviate from each other in an initial state.

14. The operation apparatus according to claim 13, wherein
a plurality of said guard electrodes are provided, and
a plurality of an electric field generating regions of said electret film are provided by arranging said guard electrodes on a surface of said electret film at a prescribed interval.

15. The operation apparatus according to claim 1, wherein
said first electrode and said electric field or magnetic field generating region of said second electrode are so formed that a longitudinal direction extends in a direction intersecting with the movement direction of said first electrode, and said first electrode and said second electrode are so arranged that the center of said first electrode in a short-direction and a center of said electric field or magnetic field generating region of said second electrode in the short-direction deviate from each other in the initial state.

16. The operation apparatus according to claim 1, wherein
said first electrode and said second electrode are arranged to overlap with each other in plan view in the initial state.

17. The operation apparatus according to claim 1, wherein
said initial state is a state where said first electrode and said second electrode relatively stand still.

18. A power generator comprising;
a collector; and
an electret film arranged to be opposed to said collector, capable of moving relatively to said collector, and including an electric field generating region, wherein
said collector and said electret film are so arranged that a center of said collector in a movement direction and a center of said electric field generating region of said electret film in said movement direction deviate from each other in an initial state, and power is generated by electrostatic induction generated by relative movement of said collector and said electret film.

19. An actuator comprising:
a first electrode; and
a second electrode arranged to be opposed to said first electrode, capable of moving relatively to said first electrode, and including an magnetic field generating region, wherein
said first electrode and said second electrode are so arranged that a center of said first electrode in a movement direction and a center of said magnetic field generating region of said second electrode in said movement direction deviate from each other in an initial state, and said first electrode and said second electrode relatively move by electromagnetic interaction between said first electrode and said second electrode.

20. The actuator according to claim 19, wherein
said first electrode includes a coil and said second electrode includes a magnet.
